(19) United States
(12) Patent Application Publication
(10) Pub. No.: US 2015/0131275 A1
(43) Pub. Date: May 14, 2015

(54) Decorative Lighting Assembly

(71) Applicant: Ryan Robl, Ellinwood, KS (US)

(72) Inventor: Ryan Robl, Ellinwood, KS (US)

(21) Appl. No.: 14/600,818

(22) Filed: Jan. 20, 2015

(51) Int. Cl. F21S 10/04; F21S 9/02

(52) U.S. Cl. CPC F21S 10/04; F21S 9/02; F21W 2121/00
USPC 362/184; 362/190; 362/374; 362/249.01

(57) ABSTRACT

A decorative lighting assembly incorporating at least a first rectangular sheet having upper and lower edges and having lateral edges; a plurality of fold scores impressed into the at least first rectangular sheet, the fold scores defining a laterally extending series of adjacent lantern wall faces; an adhesive pad fixedly attached to one of the edges among the pair of lateral edges, the adhesive pad being positioned for, upon folding of the at least first rectangular sheet creating angles between the lantern wall faces totaling 360°, holding the at least first rectangular sheet at an interior space defining configuration; perforate image indicia formed from at least a first aperture, the perforate image indicia, upon the holding of the at least first rectangular sheet at the interior space defining configuration, opening the interior space for light emission; and a first illuminator fitted for receipt within the interior space.

### FIELD OF THE INVENTION

This invention relates to decorative assemblies which may be fabricated from articles provided in the form of a kit, and which may alternatively or additionally serve as a decorative sign.

### BACKGROUND OF THE INVENTION

Both decorative lanterns and backlit signs are known. The instant inventive decorative lighting assembly provides bendable sheet configured side wall and roof or cap structures preferably provided in the form of a kit which may be assembled together for the formation of a series of decorative lanterns, each lantern among series being specially adapted to function in conjunction with the series' other lanterns as a decorative backlit sign.

### BRIEF SUMMARY OF THE INVENTION

A first structural component of the instant inventive decorative lighting assembly comprises at least a first rectangular sheet, and preferably further comprises a plurality of second rectangular sheets. In the preferred embodiment, each rectangular sheet is laterally oblongated and is composed of a malleable and easily bendable metal such as aluminum, tin, brass, or copper. Suitably, the rectangular sheets may be alternatively composed of a non-metal foldable and bendable material, such as cardboard or sheet plastic.

Further structural components of the instant inventive lighting assembly comprise a first plurality, and preferably a plurality of second pluralities of fold scores, each fold score being impressed, cut, or molded into one of the rectangular sheets. In the preferred embodiment, each fold score extends vertically, transversing its sheet from top to bottom ends. Also preferably, each plurality of fold scores is evenly arrayed laterally along its sheet to form and define within the sheet a laterally extending series of adjacent rectangular lantern walls or faces.

In a preferred embodiment, three fold scores are impressed into each of the rectangular sheet to form four lantern faces, such fold scores facilitating the manual introduction into the sheet of three substantially 90° bends which arrange the four lantern wall faces into a squared cylinder or box housing. Suitably, the number of fold scores impressed into the rectangular sheets may be limited to two, such scores defining three faces facilitating 120° bends between adjacent faces, for the creations of fabrications of triangularly configured lantern bodies. Also suitably, four or five fold scores may be alternatively impressed into each rectangular sheet for the respective formations of pentagonal (72° angled walls) or hexagonal (60° angled walls) lantern bodies. In each of the geometric configurations of the bodies of the inventive lanterns, the sum of the outside angles between its faces is substantially equal to 360°.

Upon the foldings of or introductions of bends into the rectangular sheets along their vertically impressed fold scores at appropriate angles totaling 360° as prescribed above, lateral and oppositely lateral edges or pairs of lateral edges of the rectangular sheets are advantageously drawn together to define and horizontally enclose interior lantern spaces.

To hold the sheets at their space defining configurations, first and preferably a plurality of second fastening means are provided. The fastening means are preferably integrally incorporated into the sheet components of instant inventive assembly, and such means may suitably comprise attachment tab and adhesive pad combinations. Alternatively, the fastening means may comprise attachment tab and tab engaging slot combinations. Other commonly known fastening means, such as adhesive bonds, velcro fasteners, and adhesive tape may be suitably substituted.

Further structural components of the instant inventive lighting assembly comprise first, and preferably a plurality of second perforate image indicia. In the preferred embodiment, such indicia comprise specially formed light passage apertures which are configured to suggest numbers, letters, symbols, or images of articles and things. While the perforate image indicia may suitably comprise silhouette images of articles and things, such indicia preferably comprise matrixes of hammer punch formed circular apertures. In the preferred embodiment, the instant inventive assembly includes such hammer punch and a series of punch guiding templates for use with the hammer punch. In practice and use of the instant invention, the hammer punch and templates may be advantageously utilized by a hobbyist for the creation of customized perforate image indicia.

Further structural components of the instant inventive assembly comprise at least a first and preferably a plurality of second illuminators, each illuminator being sized and fitted for receipt within one of the lanterns' interior spaces. In a preferred embodiment, the illuminators comprise faux votive candles which include a cylindrical battery housing which sculpturally depicts the body of a common paraffin votive candle, and include an upper LED light element which is a faux candle flame or translucent candle flame depicting sculpture. Electric powered incandescent bulb assemblies may be suitably alternatively utilized. Suitably, though less desirably due to heat and fire dangers, paraffin votive candles may be used. The instant inventive assembly preferably further comprises a first, and preferably a second plurality of fold scored sheets which are configurable as caps or lantern tops.

In the preferred embodiment of the instant invention, the assemblies' preferably provided pluralities of decorative lantern fabricating components are preliminarily stored and provided to the user within a kit receptacle component of the invention. In the preferred embodiment, the kit receptacle constitutes consumer sales packaging in the form of a labeled transparent plastic hang bag or a labeled transparent plastic blister pack.

In use of the instant inventive assembly, a hobbyist user of the instant invention's assembly kit may easily and conveniently fabricate a series of small decorative lanterns, each bearing customized perforate indicia created by the hobbyist through the use of the provided punch and indicia templates. Printed instruction components which are preferably provided within the kit may include detailed information which guides such customized lantern creation, and such instructions may advantageously inform of a website address which provides ready access to hobbyists' printing of a multiplicity of additional hammer punch template selections.

Upon insertions of illuminators within the lanterns' interior spaces, and upon actuations of the illuminators, the assembled lanterns conveniently and appealingly function together as a customized and user created backlit sign for displaying various words and images.

Accordingly, objects of the instant inventive include the provision of a decorative lighting assembly which incorporates structures as described above, and arranges those structures in relation to each other in manners described above, for the achievement and performance of the beneficial functions as described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a plan view of one of the rectangular sheet components of the instant inventive decorative lighting assembly.

FIG. 2 presents an reverse plan view of the rectangular sheet of FIG. 1, the view of FIG. 2 further showing surface protecting plate, hammer punch, and hammer punch template components.

FIG. 3 is a plan view of one of the cap sheet components of the instant inventive assembly.

FIG. 4 is a perspective view of a substantially assembled lantern component of the instant inventive assembly, the view further showing in exploded view or faux votive candle component.

FIG. 5 is a sectional view as indicated in FIG. 4.

FIG. 6 is a magnified view of a portion of the structure of FIG. 5, as indicated in FIG. 5.

FIGS. 7 and 8 represent various hammer punch templates components of the instant inventive assembly.

FIG. 9 presents perspective views of multiple renditions of the lantern depicted in FIG. 4.

FIG. 10 representationally portrays components, as described above, contained within a retail sales kit or receptacle component of the instant invention.

### DETAILED DESCRIPTION OF A PREFERRED EMBODIMENT

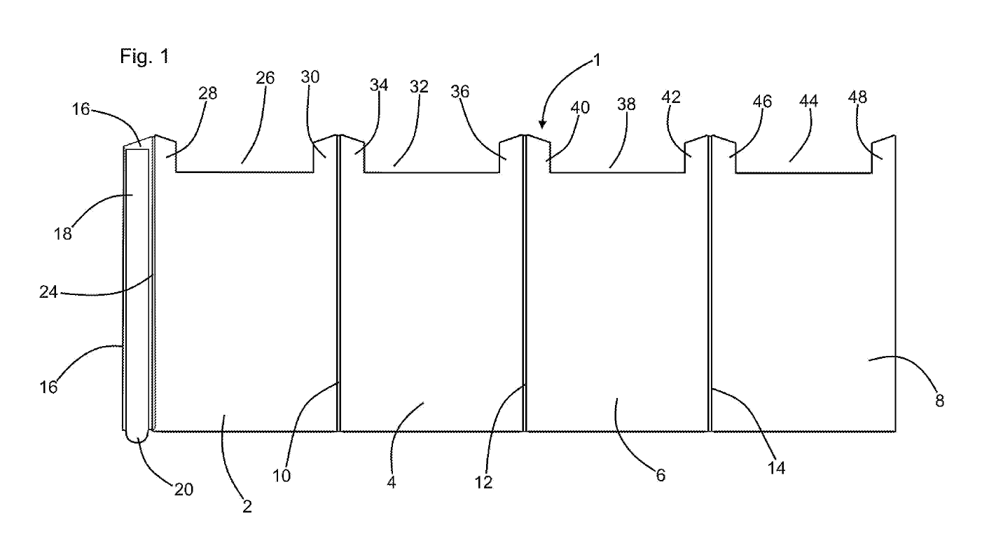

Referring now to the drawings, and in particular to Drawing FIG. 1, a rectangular sheet component of the instant inventive decorative lighting assembly is referred to generally by Reference Arrow 1. A plurality of fold scores 10, 12, and 14 are preferably impressed into the sheet 1, such fold scores dividing the sheet 1 into a lateral array or series of four adjacent lantern wall faces 2, 4, 6, and 8. Faux vent slots 26, 32, 38 and 44 are preferably formed at and within the upper edge of the rectangular sheet 1, such slots being laterally bounded by lantern roof or cap supporting columns 28,48, 30,34, 36,40, and 42,46.

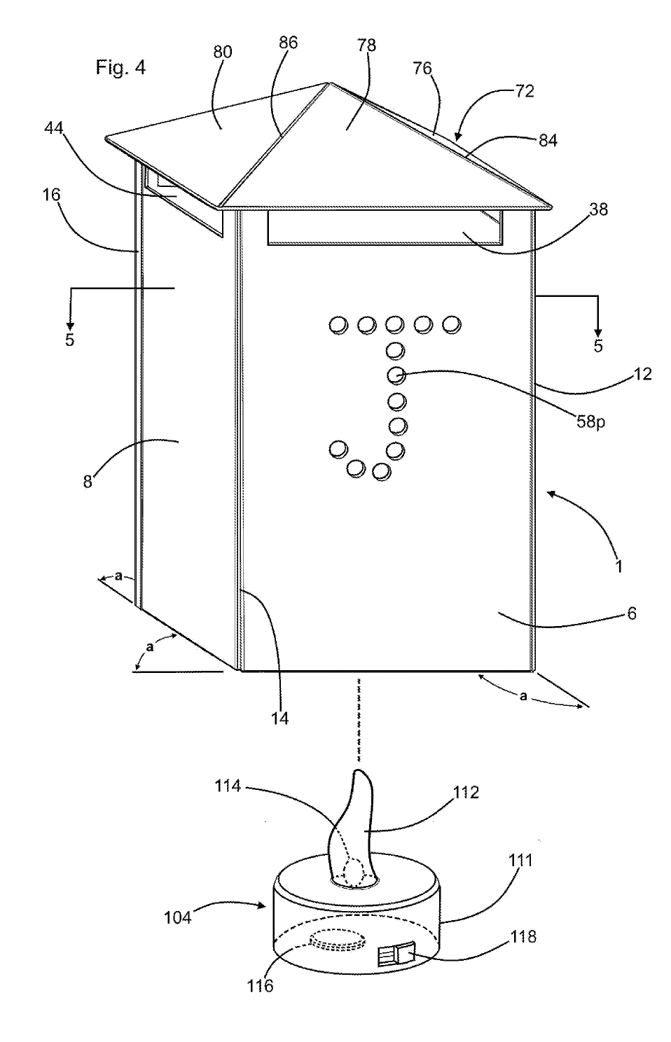

Referring further to FIG. 1, an attachment tab of flange 16 preferably extends laterally from the lateral edge of lantern wall face 2, such tab 16 and face 2 preferably being divided by a vertically extending tab positioning fold score 24. Referring further simultaneously to FIG. 6, the attachment tab 16 preferably functions, in combination with an adhesive pad 22, as attaching or fastening means. Referring further simultaneously to FIG. 4, where the lantern wall faces 2, 4, 6, and 8 are angularly bent with respect to each other along fold scores 10, 12, and 14 to create 90° outside angles “a” between such faces, the lateral and oppositely lateral edges of sheet 1 are drawn together so that faces 2 and 8 orthogonally form a fourth 90° angle. Upon such lantern face bending configuration, an interior lantern space 103 is advantageously formed and defined.

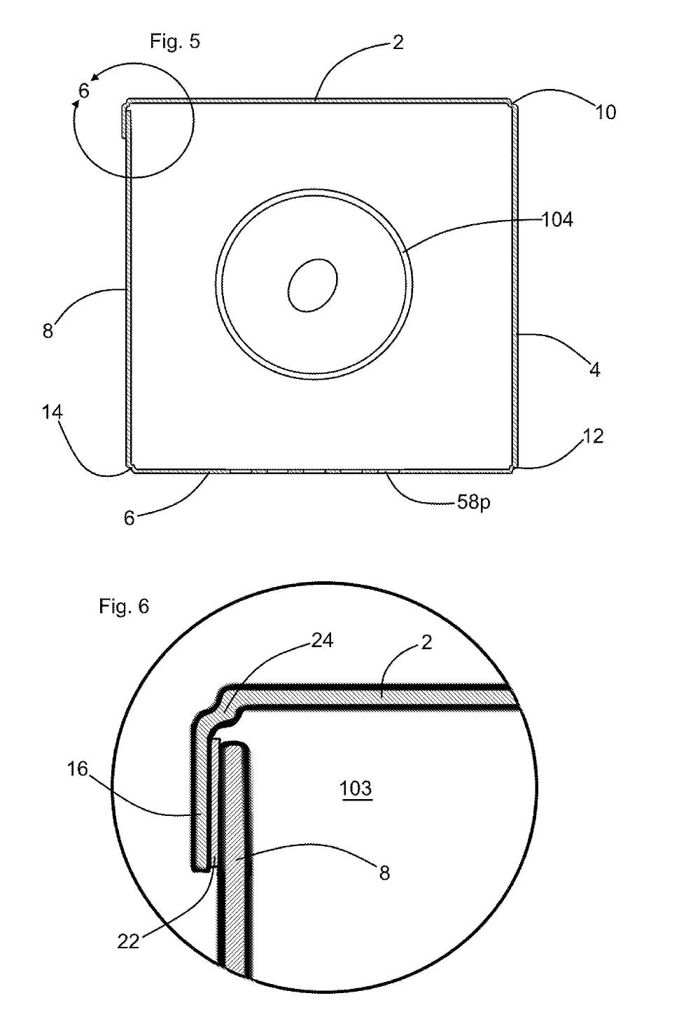

Upon manual imposition of a similar 90° bend at attachment tab 16 and about fold score 24, an end tab 20 of a waxed strip 18 may be pulled away to expose such tab's attached adhesive pad 22. Thereafter, the pad 22 may be abuttingly engaged with the outer surface of lantern face adjacent its lateral edge, such engagement securing the paired edges at the lantern body and interior space defining configuration depicted in FIGS. 4, 5, and 6.

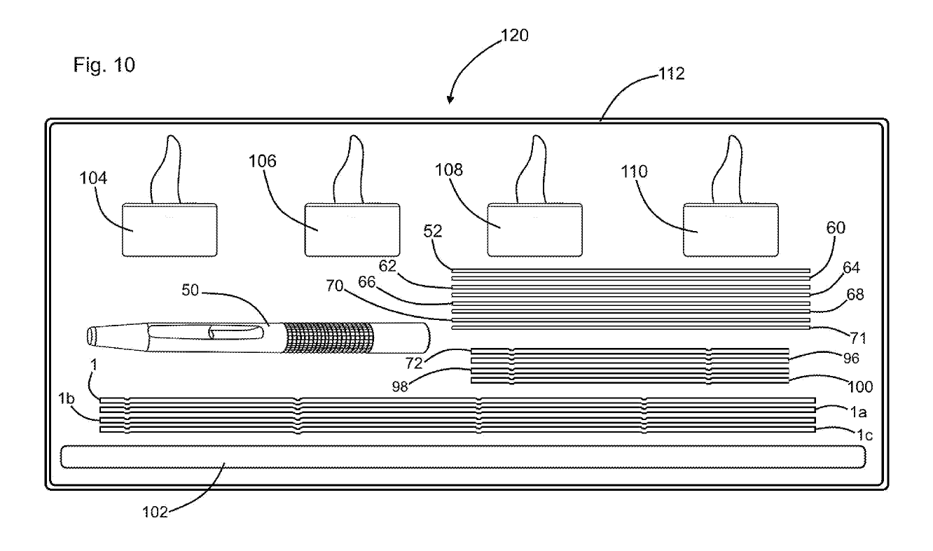

Referring simultaneously to FIGS. 1 and 10, a plurality of second rectangular sheets represented by sheets 1a, 1b, and 1c are preferably additionally provided, each second rectangular sheet preferably being configured substantially identically with the first rectangular sheet 1, and each second rectangular sheets preferably incorporating attaching means similar to the attaching means 16,22 affixed to the first rectangular sheet 1. As shown in FIG. 10, the first and plurality of second rectangular sheets 1,1a,1b,1c are preferably inserted into and are received and stored within a consumer sales package or receptacle 112 which constitutes a component of a the invention's kit assembly 120.

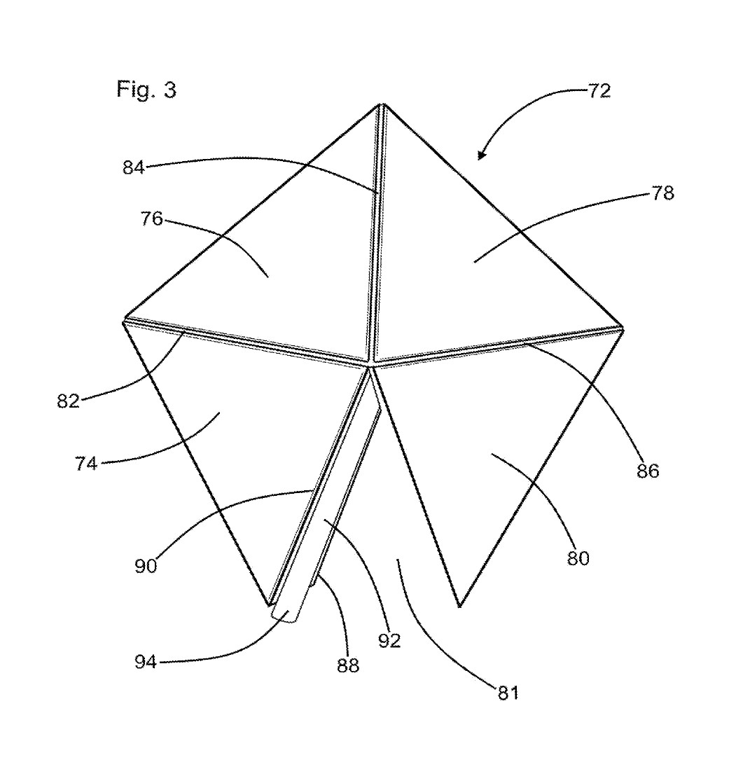

Referring simultaneously to FIGS. 3, 4, 9, and 10, further structural components of the instant inventive lighting assembly comprise at least a first cap sheet 72, and preferably comprise a plurality of second cap sheets, as represented by sheets 96, 98, and 100 drawn edge on in FIG. 10. Referring in particular to the cap sheet 72 drawn in FIG. 3, each of the cap sheets preferably includes radially arrayed fold scores 82, 84, and 86 whose number corresponds with the number of fold scores in the kit's rectangular sheets. Upon obtuse bending of cap sheet 72 along its fold scores 82, 84, and 86, a radial array of triangular hipped roof or cap panels 74, 76, 78, and 80 may be advantageously formed. A “V” slot 81 is preferably formed between facing edges of triangular panels 74 and 80 so that, upon the angled foldings of panels 74, 76, 78, and 80 along folding scores 82, 84 and 86, edges of panels 74 and 80 may be drawn together to form the hipped lantern roof or cap depicted in FIG. 4. Tab and adhesive pad fastening means 88, 92, 94 which are configured similarly with the rectangular sheet's tab and adhesive fastening means 16,18,22 are preferably provided for holding the edges of such panels 74 and 80 together. As shown in FIG. 10, the plurality of second cap sheets 96, 98, and 100 is preferably preliminarily received with the first cap sheet 72 within the receptacle 112.

Referring simultaneously to FIGS. 1, 3, 4, and 9, upon their configurations as indicated in Drawing FIG. 4, the cap sheets 72, 96, and 98 may be placed upon cap or roof supporting posts 28,48, 30,34, 36,40, and 42,46 in the manner depicted in FIG. 4. Upon such assembly and placements of the cap sheets, the faux lantern vents 26, 32, 38, and 44 are advantageously upwardly defined. In the preferred embodiment, low heat illuminating means are provided (such means being further described below), and the faux character of the vents 26, 32, 38, and 44 performs a decorative lantern portraying function. Alternatively, upon use of lit paraffin candles, vents 26, 32, 38, and 44 further perform a heat dissipating function.

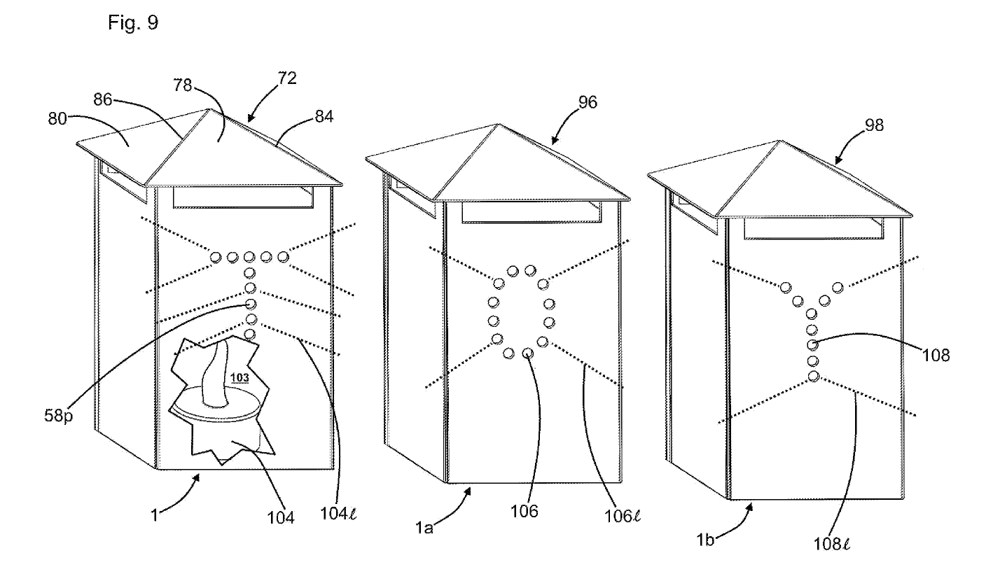

Referring to FIG. 4, the instant inventive assembly preferably further comprises at least first perforate image indicia 58p. In the example of Drawing FIG. 4, the perforate image indicia 58p comprise an array or matrix of circular apertures, each aperture extending through one of the lantern wall faces. In the example of FIG. 4, such apertures 58p are arranged to function as indicia which suggest the appearance of a capital letter “J”. Such “J” indicia is intended as being representative of number portraying indicia, along with various other symbols and pictorial images. As is further shown by the examples of FIG. 9, such other perforate image indicia may comprise indicia 106p which portrays a letter “O”, and indicia 108p which portrays a letter “Y”.

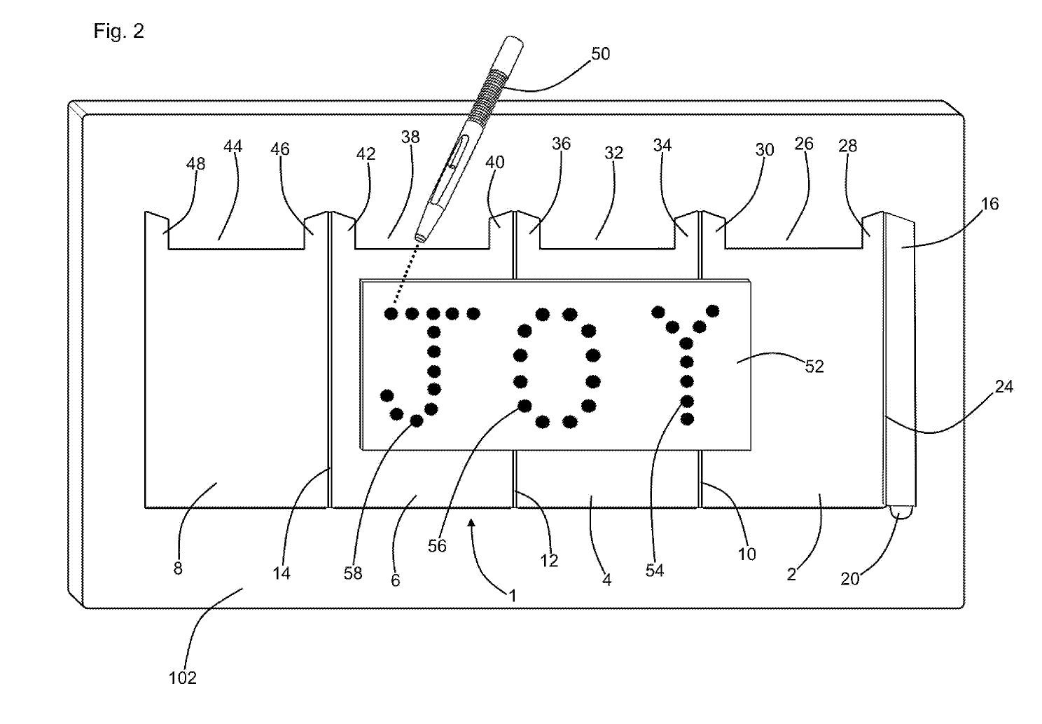

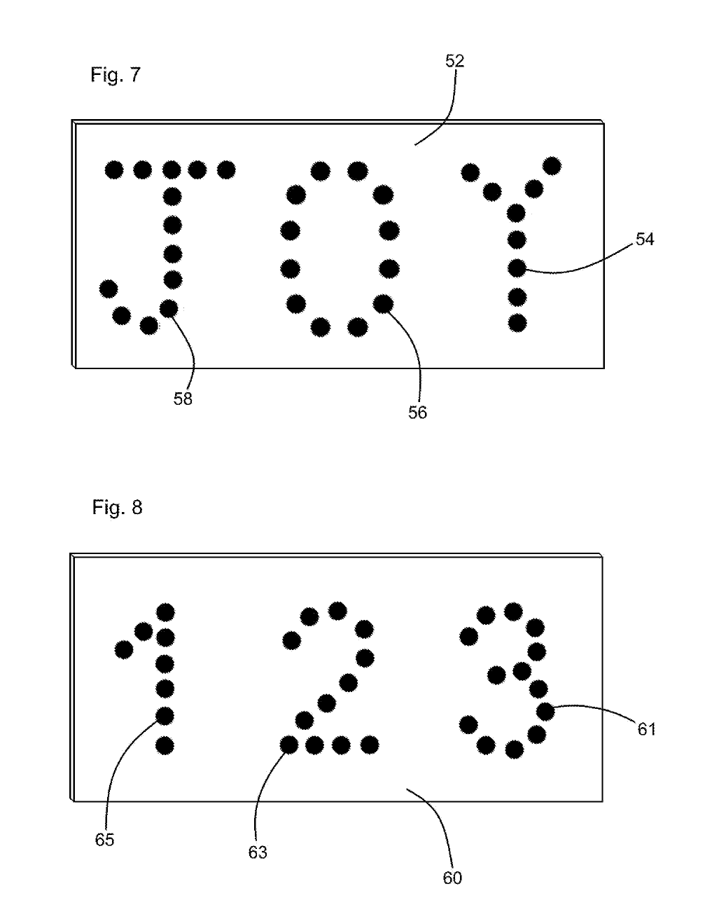

Referring simultaneously to FIGS. 2 and 10, a hammer punch 50 is preferably provided within the kit 120 as a component of the instant inventive assembly along with a plurality of hammer punch guiding templates 52, 60, 62, 64, 66, 68, 70, and 71. In a preferred embodiment, such templates are composed of paper card stock. Referring further to FIGS. 7 and 8, such templates preferably present hammer punch guiding dot arrays similar to dot arrays 58,56,54, and 65,63,61 which are respectively printed upon templates 52 and 60. Such templates and dot arrays may advantageously guide a hobbyist user of the instant inventive assembly in customized punch forming creation of various letters, numbers, pictures and symbols. Upon an exemplary use of template 52, successive punch formations of the letters “J”, “O”, and “Y”, spelling the word “JOY” is advantageously facilitated. The lettering hammer punch template 52 including the “J”, “O”, and “Y” arrays of punch guiding dots 58, 56, and 54, and the numbering template 60 including number portraying dot arrays 65, 63, and 61 are representative of multiplicities of different hammer punch guiding templates which may be provided to guide a hobbyist user in the formation of letters and numbers of all types, and in the formation of various pictorial images and symbols, all of which fall within the scope of the instant invention. Punch guide templates 52, 60, 62, 66, 68, 70, and 71 (shown edge on in FIG. 10) represent a provision within the kit 120 of a multiplicity of different hammer punch guiding templates from which a hobbyist may select and use.

Referring to FIGS. 2, 7, and 10 to aid in the use of hammer punch 50 and, for example, template 52, a durable plate 102 made of wood or plastic is preferably further provided as a kit assembly 120, such plate 102 being used to protect tabletop surfaces during hammer punch operations.

Referring to FIGS. 4 and 10, the instant inventive assembly comprises a first illuminator 104, and preferably further comprises a plurality of second illuminators which are represented by illuminators 106, 108, and 110. Each illuminator preferably comprises a faux votive candle in the form of a battery powered LED (light emitting diode) device. The preferably faux LED votive candle 104 may incorporate a candle body depicting housing 11, a faux translucent flame 112, a light emitting electric diode 114 underlying the flame 112, a battery power source 116 mounted within the candle body housing 111, and an on/off switch 118 for actuation and de-actuation of the LED 114. Such faux LED candle 104 is representative of other suitably substituted illuminating means such as battery or power cord powered incandescent bulb assemblies. Suitably, though less desirably due to fire hazards, the illuminators may comprise paraffin votive candles.

Referring simultaneously to FIGS. 1, 4, 7, 9, and 10, in use of the instant inventive decorative lighting assembly, a hobbyist user may acquire, for example at a hobby or craft store, a kit 120. Thereafter, the user may extract from the kit's packaging 112, the protector plate 102, the hammer punch 50, three of the rectangular sheets 1, 1a, and 1b, three of the cap sheets 72, 96, and 98, a hammer punch template, 52 for example, and three of the LED votives 104, 106, and 108.

Thereafter, plate 102 may be placed upon a sturdy flat surface and rectangular sheet 1 may be placed upon plate 102 in the orientation indicated in FIG. 2. Thereafter, the hammer punch template 52 may be placed upon rectangular sheet 1 in the orientation indicated so that the “J” portraying indicia array of hammer punch guiding dots 58 centrally overlies lantern face 6.

Thereafter, the hobbyist may utilize hammer punch 50 and a light hammer (not depicted within views) to repeatedly drive the punch's circular material cutting point through template 52 and through lantern face 6 at each of the dots of the “J” indicia 58.

Thereafter, rectangular sheets 1a and 1b may be similarly successively placed upon plate 102, and the hobbyist may successively hammer punch the “O” indicia 56 and the “Y” indicia 54 within lantern faces of those sheets in a fashion similar to the above described indicia punching of sheet 1.

Thereafter, referring simultaneously to FIGS. 2-5 and 9, the hobbyist user may initially bend the rectangular sheet 1 at 90° angles about the fold scores 10, 12, and 14, so that each of the outside angles “a” between the faces 2, 4, 6, and 8 substantially equals 90°. Upon such bending of sheet 1, the pair of lateral edges of the rectangular sheet 1 are drawn together to form a cross-sectionally square cylinder lantern body having outside edge angles “a” totaling 360°. The depicted 90° angles “a” are intended as being representative of alternative 120°, 72°, and 60° outside angles bends (each cumulatively totaling 360°) which may be respectively utilized in the fabrication of triangular, pentagonal, and hexagonal bodied lanterns. Where the rectangular sheets include two fold scores, a triangular cylinder body lantern having outside angles between the faces of 120° totaling 360° may be formed. Alternatively, where the rectangular sheets include four fold scores, a pentagonal cylinder body lantern having outside angles between the faces of 72° totaling 360° may be formed. To fabricate the hexagonal lantern body, five fold scores with 60° bends or outside angles totaling 360° may be used. The 90° and square lantern configuration depicted in the drawings is intended as being representative of such other multiply faced and cylindrically configured decorative lanterns.

Each sheet among the plurality of rectangular sheets 1,1a, and 1c,1b within kit 120 is preferably bendable to draw their paired lateral edges to an interior lantern space defining configuration, such defined spaces being maintained through the use of the depicted adhesive pad fastening means 16,20,22. Such adhesive pad fastening means are intended as being representative of other commonly known fastening means such as tab and slot fasteners, adhesive bonds, “Velcro” or flexible hook and loop pad fasteners, and adhesive tape.

Referring to FIGS. 4, 9, and 10, following sheet bending and edge fastening assemblies of the lantern body and cap structures 1,78, 1a,96, and 1b,98, the preferred faux LED votive candles 104, 106, and 108 may be placed upon a tabletop or counter display surface and may be actuated. Thereafter, the three substantially assembled lanterns may be respectively placed thereover, causing the faux LED votive candles 104, 106, and 108 to respectively reside within such lanterns' interior spaces. The actuations of the LED votives 104, 106, and 108, advantageously causes light 104k, 106k, and 108k to respectively emanate through the perforate indicia 58p, 56p, and 54p. Accordingly, the instant inventive assembly, in an appealing and decorative fashion, and for the sake of example, allows the hobbyist to creatively form an illuminated backlit sign highlighting the word “JOY”, while simultaneously providing and utilizing a series of room space decorating lanterns.

While the principles of the invention have been made clear in the above illustrative embodiment, those skilled in the art may make modifications in the structure, arrangement, portions, components, and method steps of the invention without departing from those principles. Accordingly, it is intended that the description and drawings be interpreted as illustrative and not in the limiting sense, and that the invention be given a scope at least commensurate with the appended claims.

The invention hereby claimed is:

1. A decorative lighting assembly comprising:
(a) at least a first rectangular sheet having upper and lower edges and having a pair of lateral edges;
(b) a plurality of fold scores extending into the at least first rectangular sheet, the fold scores defining within said sheet a laterally extending series of adjacent lantern wall faces;
(c) first fastening means fixedly attached to one of the edges among the pair of lateral edges, the first fastening means being adapted for, upon foldings of the at least first rectangular sheet creating angles between the adjacent lantern wall faces totaling 360°, holding the at least first rectangular sheet at an interior space defining configuration;
(d) perforate image indicia comprising at least a first aperture, said aperture, upon the holding of the at least first rectangular sheet at the interior space defining configuration, opening said interior space; and
(e) a first illuminator, said illuminator being receivable within said interior space.

2. The decorative lighting assembly of claim 1, and further comprising:
(a) a plurality of second rectangular sheets, each sheet among the plurality of second rectangular sheets having upper and lower edges and having a pair of lateral edges;
(b) second pluralities of fold scores extending into the second rectangular sheets, the second pluralities of fold scores defining within the second rectangular sheets second laterally extending series of adjacent lantern wall faces;
(c) a plurality of second fastening means, each fastening means among the plurality of second fastening means being fixedly attached to one of the lateral edges among the second rectangular sheets' paired lateral edges, the second fastening means being adapted for, upon foldings of the second rectangular sheets creating angles between their adjacent lantern wall faces respectively totaling 360°, holding the second rectangular sheets at second interior spaces defining configurations;
(d) second perforate image indicia comprising a plurality of second apertures, the second apertures, upon the holdings of the second rectangular sheets at their second interior spaces defining configurations, opening said second interior spaces; and
(e) a plurality of second illuminators, each illuminator among the plurality of second illuminators being receivable within one of the second interior spaces.

3. The decorative lighting assembly of claim 2 wherein each illuminator among the first and plurality of second illuminators comprises a faux votive candle.

4. The decorative lighting assembly of claim 3 further comprising a plurality of fold scored cap sheets and edge fastener combinations, said combinations being configurable for covering the at least first and second rectangular sheets' interior spaces.

5. The decorative lighting assembly of claim 4 wherein the first and plurality of second fastening means comprise a plurality of attachment tabs.

6. The decorative lighting assembly of claim 5 wherein the first and plurality of second fastening means further comprise a plurality of adhesive pads, each adhesive pad being fixedly attached to one of the attachment tabs.

7. A decorative lighting assembly comprising:
(a) a kit receptacle;
(b) a plurality of rectangular sheets received within the kit receptacle, each rectangular sheet having upper and lower edges and having a pair of lateral edges, and each rectangular sheet having a plurality of fold scores defining within said each rectangular sheet a laterally extending series of adjacent lantern wall faces;
(c) fastening means fixedly attached to lateral edges among the rectangular sheets' pairs of lateral edges, the fastening means being adapted for, upon foldings of the rectangular sheets creating angles between their adjacent lantern walls faces respectively totaling 360°, holding the rectangular sheets at interior space defining configurations;
(d) a plurality of perforate image punch templates, said templates being received within the kit receptacle;
(e) a hammer punch received within the kit receptacle, the hammer punch being adapted for template guided perforation of the lantern wall faces; and
(f) a plurality of faux LED votive candles received within the kit receptacle, said candles being sized for, upon the holdings of the rectangular sheets at their interior space defining configurations, receipt within said interior spaces.

8. The decorative lighting assembly of claim 7 further comprising a plurality of fold scored cap sheets and edge fastener combinations received within the kit receptacle, said combinations being configurable for covering the rectangular sheets' interior spaces.
